(19) United States
(12) Patent Application Publication
(10) Pub. No.: US 2026/0227915 A1
(43) Pub. Date: Aug. 6, 2026

(54) MEMORY SYSTEM AND METHOD

(71) Applicant: Kioxia Corporation, Tokyo (JP)

(72) Inventors: Yusuke TAKAHASHI, Narashino Chiba (JP); Shin TAKASAKA, Yokohama Kanagawa (JP); Makoto DOMON, Sagamihara Kanagawa (JP)

(73) Assignee: Kioxia Corporation, Tokyo (JP)

(21) Appl. No.: 19/235,704

(22) Filed: Jun. 12, 2025

(30) Foreign Application Priority Data
Feb. 5, 2025 (JP) 2025-017210

(51) Int. Cl. G06F 3/06

(52) U.S. Cl. CPC G06F 3/0619; G06F 3/0652; G06F 3/0659; G06F 3/0679

(57) ABSTRACT

According to an embodiment, a memory controller executes, multiple times, a first operation of storing first information in each of storage area units. In each of the multiple times of the first operation, the memory controller executes an erase operation on a storage area unit including no free area capable of storing the first information and stores the first information after the erase operation. The memory controller stores, without executing the erase operation, the first information in a storage area unit including the free area. The memory controller stores the first information in sub storage areas having different sub storage area numbers in at least two storage area units and thereby causes at least one of the at least two storage area units to include the free area after the first operation.

### CROSS-REFERENCE TO RELATED APPLICATIONS

This application is based upon and claims the benefit of priority from Japanese Patent Application No. 2025-017210, filed on Feb. 5, 2025, the entire contents of which are incorporated herein by reference.

### FIELD

Embodiments described herein relate generally to a memory system and a method.

### BACKGROUND

In a memory system having a nonvolatile memory such as a NAND flash memory, copies of important data are generated, and the copies of data are respectively stored in different blocks. The block, which is a sub-array that constitutes a memory cell array provided in the nonvolatile memory, is a unit of an erase operation.

### BRIEF DESCRIPTION OF THE DRAWINGS

FIG. 1 is a diagram illustrating a configuration of a memory system according to a first embodiment;

FIG. 2 is a diagram illustrating a configuration of a memory chip according to the first embodiment;

FIG. 3 is a diagram illustrating a circuit configuration of a block according to the first embodiment;

FIG. 4 is a diagram for explaining management information according to the first embodiment;

FIG. 5 is a diagram for explaining an example of transition of a location where a copy of primary management information is to be stored according to the first embodiment;

FIG. 6 is a diagram for explaining a timing of an erase operation for each primary block according to the first embodiment;

FIG. 7 is a flowchart illustrating a procedure of a series of operations related to non-volatilization of normal management information according to the first embodiment;

FIG. 8 is a flowchart illustrating a procedure of a multiple storing operation according to the first embodiment;

FIG. 9 is a flowchart illustrating a procedure of a series of operations related to loading of normal management information according to the first embodiment;

FIG. 10 is a diagram for explaining an example of a multiple storing operation according to a second embodiment;

FIG. 11 is a diagram illustrating a configuration of firmware management information according to the second embodiment;

FIG. 12 is a diagram for explaining an example of a multiple storing operation in which the feature according to the second embodiment is more generalized;

FIG. 13 is another diagram for explaining an example of a multiple storing operation in which the feature according to the second embodiment is more generalized; and

FIG. 14 is a flowchart illustrating a procedure of an operation when booting a memory system according to the second embodiment.

### DETAILED DESCRIPTION

According to the present embodiment, a memory system includes a nonvolatile first memory and a memory controller. The nonvolatile first memory includes a plurality of storage area units, each of the plurality of storage area units being a unit of an erase operation. Each of the plurality of storage area units includes a plurality of sub storage areas. The memory controller is configured to manage, for each of the plurality of storage area units, each of the plurality of sub storage areas by using a sub storage area number in accordance with an order of data storage in the corresponding storage area unit. The memory controller is configured to execute, on each of the plurality of storage area units, a first operation of storing first information a plurality of times. Each of the plurality of times of the first operation includes, for a first storage area unit that is one of the plurality of storage area units and includes no free area capable of storing the first information, executing the erase operation on the first storage area unit and storing the first information in the first storage area unit after the erase operation. Each of the plurality of times of the first operation further includes, for a second storage area unit that is one of the plurality of storage area units and includes a free area capable of storing the first information, storing the first information in the second storage area unit without executing the erase operation on the second storage area unit. Each of the plurality of times of the first operation further includes, in at least two of the plurality of storage area units, storing the first information in sub storage areas having different sub storage area numbers, and thereby causing at least one of the at least two storage area units to include the free area after the first operation.

Hereinafter, memory systems and methods according to embodiments will be described in detail with reference to the accompanying drawings. Note that the present invention is not limited by these embodiments.

### First Embodiment

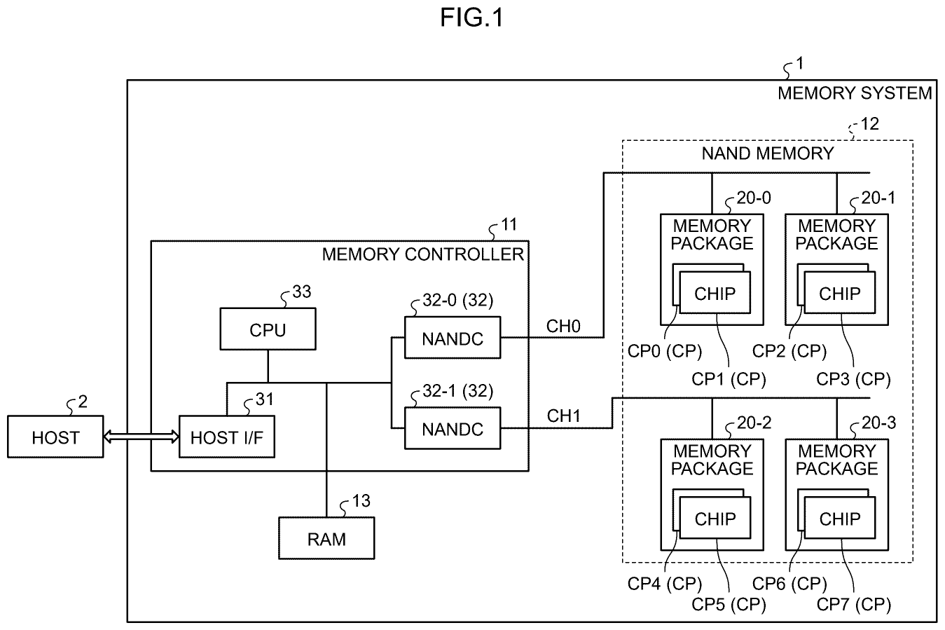

FIG. 1 is a diagram illustrating a configuration of a memory system according to the first embodiment.

As illustrated in FIG. 1, a memory system 1 can be connected to a host 2 via a predetermined communication interface. The host 2 is, for example, a processor, a personal computer, a personal digital assistant, or a server. Various access commands are input from the host 2 to the memory system 1. The various access commands include a write command, a read command, and the like.

The access command includes a logical address. The memory system 1 provides a logical address space to the host 2. The logical address is address information indicating a location in the logical address space. The host 2 designates a location where user data is written or a location where user data is read by using the logical address. That is, the logical address is location information indicating an access destination.

The memory system 1 includes a memory controller 11, a NAND flash memory 12, and a random access memory (RAM) 13. Hereinafter, the NAND flash memory 12 will be referred to as the NAND memory 12.

The NAND memory 12 is a nonvolatile memory that functions as a storage. The NAND memory 12 includes one or more memory chips CP. Eight memory chips CP0 to CP7 are illustrated as an example of the one or more memory chips CP. Some or all of the one or more memory chips CP may be sealed with resin or the like to form one or more memory packages. The NAND memory 12 according to the present embodiment includes, as an example, a memory package 20-0 including memory chips CP0 and CP1, a memory package 20-1 including memory chips CP2 and CP3, a memory package 20-2 including memory chips CP4 and CP5, and a memory package 20-3 including memory chips CP6 and CP7.

The memory controller 11 and the NAND memory 12 are connected via one or more channels. As an example, the memory system 1 according to the present embodiment includes two channels CH0 and CH1. The two channels CH0 and CH1 are connected to the memory controller 11. The memory packages 20-0 and 20-1 are connected to the channel CH0, and the memory packages 20-2 and 20-3 are connected to the channel CH1.

Note that the number of channels, the number of memory chips CP, the number of memory packages 20, and the wiring between the memory controller 11 and each of the memory chips CP included in the memory system 1 are not limited to these examples.

The memory controller 11 can be configured as a system-on-a-chip (SoC). Alternatively, the memory controller 11 can be constituted with a plurality of chips. A part or all of the memory controller 11 can also be configured as a field-programmable gate array (FPGA) or an application specific integrated circuit (ASIC).

The memory controller 11 executes various processes including data transfer between the host 2 and the NAND memory 12. The memory controller 11 includes a host interface circuit (host I/F) 31, one or more NAND controllers (NANDCs) 32, and a central processing unit (CPU) 33.

The host I/F 31 controls transfer of information such as commands and data to and from the host 2.

The CPU 33 controls the entire memory controller 11 based on a firmware program (hereinafter, referred to as firmware).

The NANDC 32 transfers a command for accessing the NAND memory 12 via the channel to a target memory chip CP or transfers data corresponding to the command to the NAND memory 12 based on a request from the CPU 33. The access to the NAND memory 12 includes writing data, reading data, and erasing data.

In the example illustrated in FIG. 1, the memory controller 11 includes two NANDCs 32-0 and 32-1 as an example of the one or more NANDCs 32. The NANDC 32-0 controls transfer of commands and data via the channel CH0. The NANDC 32-1 controls transfer of commands and data via the channel CH1. The number of NANDCs 32 included in the memory controller 11 is not limited to two.

The RAM 13 is a volatile memory that provides an area as a buffer or a cache to the memory controller 11. The memory controller 11 can use the RAM 13 as a buffer for data to be transferred between the host 2 and the NAND memory 12 or as an area in which various types of management information are temporarily stored.

In the example illustrated in FIG. 1, the RAM 13 is disposed outside the memory controller 11. The RAM 13 may be built in the memory controller 11. The type of the RAM 13, the number of the RAMs 13, and the location of the RAM 13 in the memory system 1 are optional. For example, the RAM 13 may be a dynamic random access memory (DRAM), a static random access memory (SRAM), or a combination thereof. In a case where the RAM 13 is a combination of a DRAM and an SRAM, the SRAM may be built in the memory controller 11, and the DRAM may be disposed outside the memory controller 11.

The function of each unit in the memory controller 11 may be implemented by dedicated hardware in the memory controller 11 or may be implemented by the CPU 33 that executes firmware.

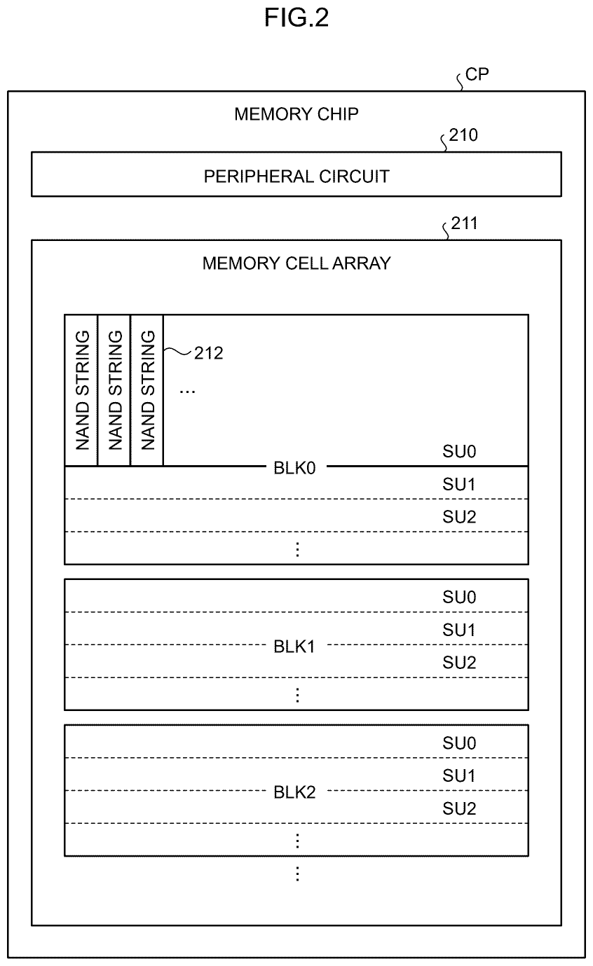

FIG. 2 is a diagram illustrating a configuration of the memory chip CP according to the first embodiment. The memory chip CP includes a peripheral circuit 210 and a memory cell array 211.

The memory cell array 211 includes a plurality of blocks BLK (BLK0, BLK1, BLK2, . . . ). Each block BLK includes a plurality of string units SU (SU0, SU1, SU2, . . . ). Each string unit SU includes a plurality of NAND strings 212. Each NAND string 212 includes a plurality of nonvolatile memory cell transistors connected in series. Note that the number of NAND strings 212 included in the string unit SU is optional. The number of memory cell transistors included in the NAND string 212 is also optional.

The peripheral circuit 210 includes, for example, a row decoder, a column decoder, a sense amplifier, a latch circuit, and a voltage generation circuit. Upon receiving a command from the memory controller 11, the peripheral circuit 210 executes an operation in accordance with the received command.

The peripheral circuit 210 can execute a data-in operation, a program operation, a sense operation, a data-out operation, an erase operation, or the like in accordance with the received command. The data-in operation is an operation of taking write data input from the memory controller 11 to the memory chip CP into the latch circuit included in the peripheral circuit 210. The program operation is an operation of writing the data taken into the latch circuit by the data-in operation to the memory cell array 211. The sense operation is an operation of transferring data stored in the memory cell array 211 to the latch circuit included in the peripheral circuit 210. The data-out operation is an operation of outputting the data stored in the latch circuit to the memory controller 11. The erase operation is an operation of erasing data stored in the memory cell array 211.

In a write operation, the memory controller 11 causes the peripheral circuit 210 to take write data into the latch circuit by a data-in operation. Thereafter, the memory controller 11 causes the peripheral circuit 210 to store the write data into the memory cell array 211 by a program operation.

In a read operation, the memory controller 11 causes the peripheral circuit 210 to transfer data stored in the memory cell array 211 to the latch circuit by a sense operation. Thereafter, the memory controller 11 causes the peripheral circuit 210 to output the data stored in the latch circuit to the memory controller 11 by a data-out operation. In a case where the data to be read is already stored in the latch circuit, the sense operation can be omitted.

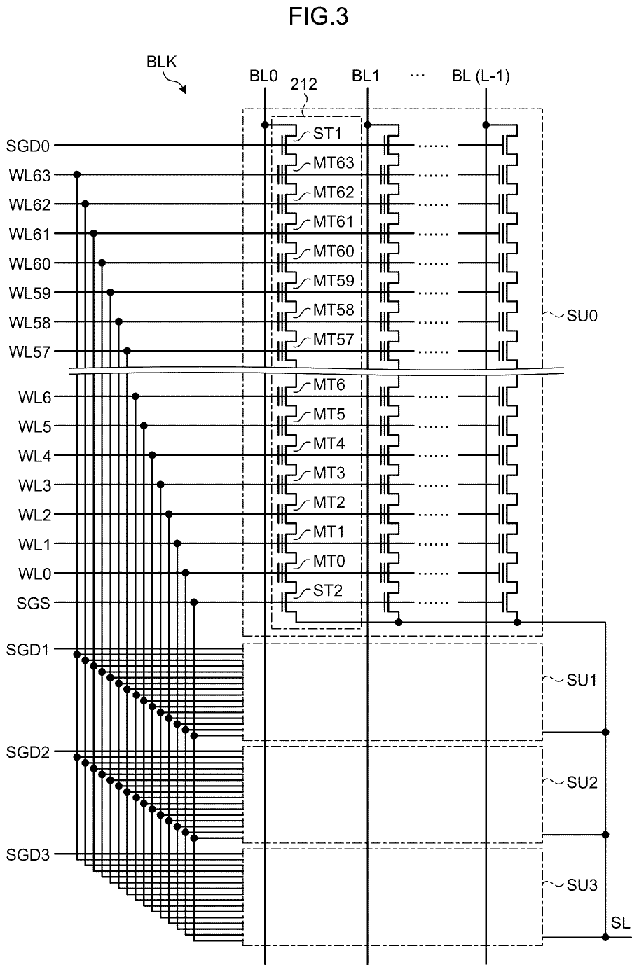

FIG. 3 is a diagram illustrating a circuit configuration of the block BLK according to the first embodiment. The blocks BLK have the same configuration. The block BLK includes, for example, four string units SU0 to SU3. Each string unit SU includes a plurality of NAND strings 212.

Each NAND string 212 includes, for example, 64 memory cell transistors MT (MT0 to MT63) and select transistors ST1 and ST2. The memory cell transistor MT includes a control gate and a charge storage layer, and stores data in a nonvolatile manner according to a threshold voltage. The 64 memory cell transistors MT (MT0 to MT63) are connected in series between a source of the select transistor ST1 and a drain of the select transistor ST2. Note that the memory cell transistor MT may be a metal-oxide-nitride-oxide-silicon (MONOS) type transistor in which an insulating film is used for the charge storage layer, or may be a floating gate (FG) type transistor in which a conductive film is used for the charge storage layer. The number of memory cell transistors MT in the NAND string 212 is not limited to 64.

The gates of the select transistors ST1 included in the string units SU0 to SU3 are connected to select gate lines SGD0 to SGD3, respectively. On the other hand, the gates of the select transistors ST2 included in the string units SU0 to SU3 are commonly connected to, for example, a select gate line SGS. Note that the gates of the select transistors ST2 included in the string units SU0 to SU3 may be connected to select gate lines SGS0 to SGS3 (not illustrated) different for the respective string units SU. The control gates of the memory cell transistors MT0 to MT63 included in the same block BLK are commonly connected to the word lines WL0 to WL63, respectively.

The drains of the select transistors ST1 of the NAND strings 212 included in the string unit SU are respectively connected to different bit lines BL (BL0 to BL(L−1), where L is a natural number of 2 or larger). The bit line BL commonly connects one NAND string 212 included in each string unit SU among the blocks BLK. The sources of the select transistors ST2 are commonly connected to a source line SL.

Thus, the string unit SU is a set of NAND strings 212 that are respectively connected to different bit lines BL and connected to the same select gate line SGD. The block BLK is a set of string units SU sharing the word lines WL. The memory cell array 211 is a set of blocks BLK sharing at least one bit line BL.

The program operation and the sense operation can be collectively executed by the peripheral circuit 210 for the memory cell transistors MT connected to one word line WL in one string unit SU. A set of memory cell transistors MT selected collectively during the program operation and the sense operation is referred to as a memory cell group. The memory cell group includes one or more pages, which are storage areas, in accordance with the number of bits of data stored in each memory cell transistor MT. For example, one page stores a set of 1-bit data at the same bit location in the data stored in memory cell transistors MT of the memory cell group. Hereinafter, the storage capacity of one page will be referred to as a page size.

Each page included in one block BLK is given a unique identification number in the block BLK. The identification number given to each page will be referred to as a page number. The program operation for each block BLK is executed, for example, in order of page number. Thus, the page numbers indicate the order of data storage in storage areas (namely, a plurality of pages) included in the block BLK.

The erase operation is executed by the peripheral circuit 210 in units of blocks BLK. That is, the block BLK is a unit of an erase operation. The erase operation is an operation of erasing (or initializing) data stored in the memory cell transistors MT by making the threshold voltage of each of the memory cell transistors MT included in the block BLK from which the data is to be erased lower than a predetermined voltage. All the data stored in one block BLK is erased collectively.

The configuration of the memory cell array 211 is not limited to the configuration illustrated in FIGS. 2 and 3. For example, the memory cell array 211 may have a configuration in which the NAND strings 212 are two-dimensionally or three-dimensionally arranged.

The memory controller 11 uses various types of management information.

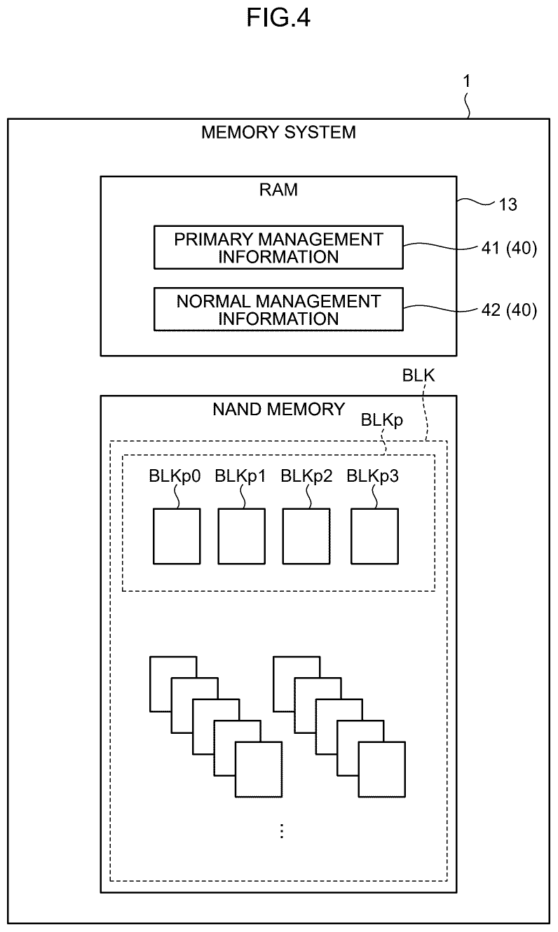

FIG. 4 is a diagram for explaining the management information according to the first embodiment.

The RAM 13 stores various types of management information 40. The memory controller 11 refers to and updates the management information 40 during operation. The management information 40 includes, for example, primary management information 41 and normal management information 42. The primary management information 41 is management information 40 that is more important than the normal management information 42.

In one example, the normal management information 42 is a logical-to-physical address translation table. The logical-to-physical address translation table is information indicating a correspondence relationship between a logical address and a physical address indicating each location for storage in the NAND memory 12. The logical-to-physical address translation table is updated for each write operation.

In one example, the primary management information 41 is information indicating a location where the normal management information 42 is to be stored in the NAND memory 12.

The management information 40 in the RAM 13 disappears from the RAM 13 when a power outage occurs, namely, when the power supply to the memory system 1 is cut off. Thus, the memory controller 11 generates a copy of the management information 40 in the RAM 13 at an appropriate time, and stores the copy of the management information 40 in the NAND memory 12. Even if the management information 40 disappears from the RAM 13 due to a power outage, when the memory system 1 is rebooted after the power outage, the memory controller 11 loads the copy of the management information 40 stored in the NAND memory 12 into the RAM 13. As a result, the management information 40 in the RAM 13 after the reboot is returned to the same state as before the power outage. Hereinafter, such an operation of generating a copy of data in the RAM 13 and storing the copy of the data in the NAND memory 12 will be referred to as non-volatilizing the data.

The memory controller 11 updates the primary management information 41 in response to the non-volatilization of the normal management information 42. Specifically, the memory controller 11 modifies the primary management information 41 to update an address indicating a location where the normal management information 42 is stored with a new address indicating a location where a copy of the normal management information 42 is to be stored by the non-volatilization.

By non-volatilizing the normal management information 42, a copy of the entire normal management information 42 may be stored in the NAND memory 12, or only an updated part of the normal management information 42 may be stored in the NAND memory 12. In a case where only the updated part of the normal management information 42 is stored in the NAND memory 12, the normal management information 42 is stored in the NAND memory 12 in a fragmented manner. Therefore, the location where the normal management information 42 is to be stored is recorded in the primary management information 41 for each fragment of the normal management information 42.

In addition, similarly to the normal management information 42, the primary management information 41 is also non-volatilized at an appropriate time.

The possibility of failure in non-volatilizing the management information 40 is not zero. In particular, if the primary management information 41 fails to be non-volatilized and is lost from the memory controller 11, this will cause a serious disruption to the operation of the memory system 1. Therefore, when the primary management information 41 is non-volatilized, the memory controller 11 generates copies of the primary management information 41 and respectively stores the copies in different blocks BLK. Even if some of the copies of the primary management information 41 fails to be stored in the NAND memory 12, if the others are successfully stored in the NAND memory 12, the latest primary management information 41 is prevented from being lost from the memory system 1. Thus, the risk that the primary management information 41 will be lost from the memory system 1 is reduced.

Hereinafter, the non-volatilizing operation executed on the primary management information 41, namely, the operation of respectively storing copies of certain data into the blocks BLK will be referred to as a multiple storing operation.

Among the blocks BLK included in the NAND memory 12, two or more blocks BLK are set as locations where the copies of the primary management information 41 are to be stored in the multiple storing operation. The block BLK set as the location where the copy of the primary management information 41 is to be stored in the multiple storing operation will be referred to as the primary block BLKp.

In the present embodiment, (M+1) blocks BLK are set as the primary blocks BLKp. Here, M is an integer of 1 or larger. In the example illustrated in FIG. 4, four blocks BLK are set as the primary blocks BLKp. Thus, M is 3. The four primary blocks BLKp are a primary block BLKp0, a primary block BLKp1, a primary block BLKp2, and a primary block BLKp3.

The memory system 1 is configured to execute a power loss protection (PLP) operation. The PLP operation is an operation in which, when a power outage occurs during the operation of the memory system 1, the memory controller 11 stores, in the NAND memory 12, data that has not yet been stored in the NAND memory 12 among the data stored in the RAM 13, by using electric energy stored in a capacitor (not illustrated in FIG. 1) included in the memory system 1. Objects to be stored in the NAND memory 12 by the PLP operation include, for example, the management information 40, and the write data received from the host 2 and buffered in the RAM 13.

The PLP operation is implemented by finite electric energy stored in the capacitor. Therefore, the time for executing the PLP operation is finite.

Two techniques to be compared with the first embodiment will be described. The two techniques to be compared with the first embodiment will be referred to as a first comparative example and a second comparative example.

According to the first comparative example, in a multiple storing operation, copies of primary management information are stored in pages having the same page number of different primary blocks. Therefore, according to the first comparative example, there may be no free page in any of the primary blocks at one multiple storing operation timing, making it necessary to perform an erase operation for each of the primary blocks. In such a case, the erase operations are performed for those primary blocks, and copies of the primary management information are stored in those primary blocks after the erase operations.

In general, the erase operation takes a significantly longer time than the write operation. Therefore, in the first comparative example, in a case where there is no free page in any primary block, it is required to wait for a time corresponding to one erase operation in any primary block in storing a copy of primary management information. In particular, when such a case occurs during a PLP operation, which has a limited operable time, there is a possibility that the storage of the copy of the primary management information cannot be completed in any primary block.

According to the second comparative example, similarly to the first comparative example, in a multiple storing operation, copies of primary management information are stored in pages having the same page number of different primary blocks. Then, in the second comparative example, when erase operations are required at one multiple storing operation timing for the primary blocks, the erase operations are executed for the primary blocks sequentially (that is, not at once) so that the primary management information can be read from one or more of the primary blocks.

According to the second comparative example, similarly to the first comparative example, there is a possibility that the storage of the copy of the primary management information cannot be completed in any primary block in a situation where the operable time is limited. Moreover, the erase operations are sequentially executed on the primary blocks, resulting in the time required for the multiple storing operation becoming significantly longer than that in the first comparative example. Therefore, during a period in which the multiple storing operation is being executed, the performance in responding to the host significantly deteriorates.

In the first embodiment, in order to perform erase operations at distributed timings among the primary blocks BLKp, copies of the primary management information 41 are stored in pages having different page numbers of different primary blocks BLKp.

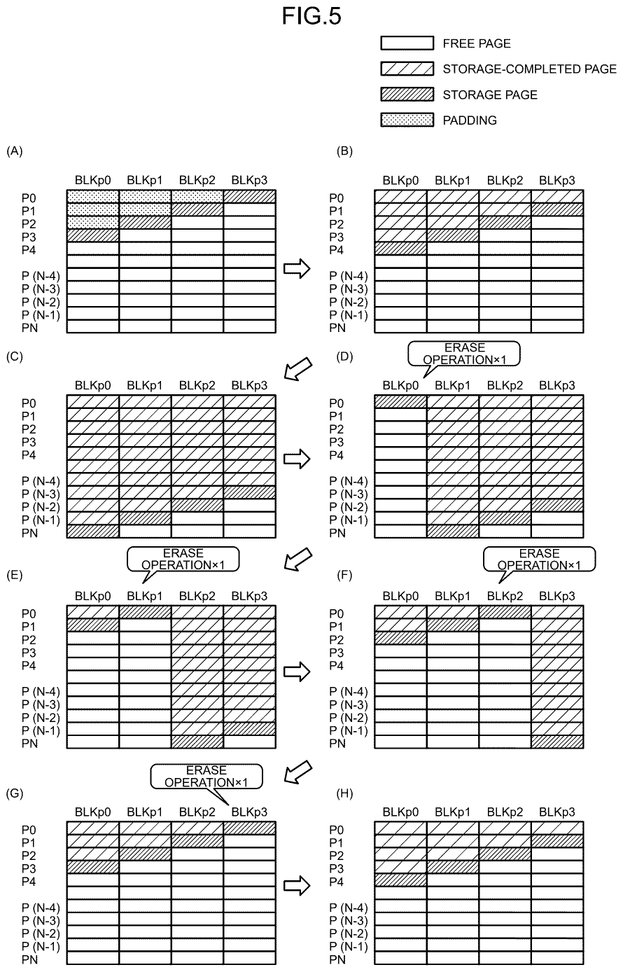

FIG. 5 is a diagram for explaining an example of transition of a location where a copy of the primary management information 41 is stored according to the first embodiment. In FIG. 5, a page whose page number is x (where x is numerical information) is referred to as a page Px. In addition, each primary block BLKp includes (N+1) pages from a page P0 to a page PN.

In a first multiple storing operation, as illustrated in part (A), the memory controller 11 stores a copy of the primary management information 41 into the page P3 of the primary block BLKp0, the page P2 of the primary block BLKp1, the page P1 of the primary block BLKp2, and the page P0 of the primary block BLKp3.

In the first multiple storing operation, the memory controller 11 performs padding on the pages P0 to P2 of the primary block BLKp0, the pages P0 and P1 of the primary block BLKp1, and the page P0 of the primary block BLKp2. The padding may be executed in advance at the time of manufacturing the memory system 1. Alternatively, the first multiple storing operation itself, which includes the padding, may be executed in advance at the time of manufacturing the memory system 1.

In a second multiple storing operation, as illustrated in part (B), the memory controller 11 stores a copy of the primary management information 41 into the page P4 of the primary block BLKp0, the page P3 of the primary block BLKp1, the page P2 of the primary block BLKp2, and the page P1 of the primary block BLKp3. Thus, in each of the four primary blocks BLKp, the copy of the primary management information 41 is stored in a page next to the page in which the copy of the primary management information 41 was stored last.

In an (N−2)th multiple storing operation, as illustrated in part (C), the memory controller 11 stores a copy of the primary management information 41 into the page PN of the primary block BLKp0, the page P(N−1) of the primary block BLKp1, the page P(N−2) of the primary block BLKp2, and the page P(N−3) of the primary block BLKp3. Through the (N−2)th multiple storing operation, the primary blocks BLKp1, BLKp2, and BLKp3 have free pages, but the primary block BLKp0 does not have a free page.

Note that the free page is a page on which a program operation has yet not been executed after the last erase operation is executed. Thus, the free page is a page in which the data-erased state is maintained.

In an (N−1)th multiple storing operation, as illustrated in part (D), the memory controller 11 stores a copy of the primary management information 41 into the page PN of the primary block BLKp1, the page P(N−1) of the primary block BLKp2, and the page P(N−2) of the primary block BLKp3. Since the primary block BLKp0 has no free page, the memory controller 11 executes an erase operation on the primary block BLKp0, and stores the copy of the primary management information 41 into the page P0 of the primary block BLKp0 after the erase operation. Through the (N−1)th multiple storing operation, the primary blocks BLKp0, BLKp2, and BLKp3 have free pages, but the primary block BLKp1 does not have a free page.

In an Nth multiple storing operation, as illustrated in part (E), the memory controller 11 stores a copy of the primary management information 41 into the page P1 of the primary block BLKp0, the page PN of the primary block BLKp2, and the page P(N−1) of the primary block BLKp3. Since the primary block BLKp1 has no free page, the memory controller 11 executes an erase operation on the primary block BLKp1, and stores the copy of the primary management information 41 into the page P0 of the primary block BLKp1 after the erase operation. Through the Nth multiple storing operation, the primary blocks BLKp0, BLKp1, and BLKp3 have free pages, but the primary block BLKp2 does not have a free page.

In an (N+1)th multiple storing operation, as illustrated in part (F), the memory controller 11 stores a copy of the primary management information 41 into the page P2 of the primary block BLKp0, the page P1 of the primary block BLKp1, and the page PN of the primary block BLKp3. Since the primary block BLKp2 has no free page, the memory controller 11 executes an erase operation on the primary block BLKp2, and stores the copy of the primary management information 41 into the page P0 of the primary block BLKp2 after the erase operation. Through the (N+1)th multiple storing operation, the primary blocks BLKp0, BLKp1, and BLKp2 have free pages, but the primary block BLKp3 does not have a free page.

In an (N+2)th multiple storing operation, as illustrated in part (G), the memory controller 11 stores a copy of the primary management information 41 into the page P3 of the primary block BLKp0, the page P2 of the primary block BLKp1, and the page P1 of the primary block BLKp2. Since the primary block BLKp3 has no free page, the memory controller 11 executes an erase operation on the primary block BLKp3, and stores the copy of the primary management information 41 into the page P0 of the primary block BLKp3 after the erase operation.

Thereafter, the transition from the state illustrated in part (B) to the state illustrated in part (G) is repeated. For example, in an (N+3)th multiple storing operation, as illustrated in part (H), the memory controller 11 stores a copy of the primary management information 41 into the page P4 of the primary block BLKp0, the page P3 of the primary block BLKp1, the page P2 of the primary block BLKp2, and the page P1 of the primary block BLKp3. The state illustrated in this part (H) is equivalent to the state illustrated in part (B).

In this manner, the four copies of the primary management information 41 are respectively stored in pages having different page numbers of the four primary blocks BLKp. Therefore, as illustrated in parts (D) to (G), even if one primary block BLKp does not have a free page, the other three primary blocks BLKp have free pages. Therefore, the memory controller 11 starts storing copies of the primary management information 41 without performing erase operations with respect to the other three primary blocks BLKp. In this manner, it is possible to start storing copies of the primary management information 41 without performing erase operations with respect to at least three primary blocks BLKp. Therefore, unlike the first comparative example, even when a multiple storing operation is started during a PLP operation, it is possible to reduce the risk that the time is insufficient for storing copies of the primary management information 41 in all the primary blocks BLKp.

An erase operation for each primary block BLKp is executed at a different multiple storing operation timing. Therefore, even if an erase operation is required during a multiple storing operation, the multiple storing operation can be completed in a shorter time than in the second comparative example.

Note that, during one multiple storing operation, the order of storing copies of the primary management information 41 in primary blocks BLKp having free pages is optional. The memory controller 11 may simultaneously store copies of the primary management information 41 in all the primary blocks BLKp having free pages. Alternatively, the memory controller 11 may sequentially store copies of the primary management information 41 in the primary blocks BLKp having free pages.

In one example, the memory controller 11 stores the copies of the primary management information 41 in the primary blocks BLKp having free pages in order of page number, starting from a page having the largest page number where a copy of the primary management information 41 is to be stored.

In the example illustrated in FIG. 5, the page number of the location where a copy of the primary management information 41 is stored in each primary block BLKp differs by one from the page number of the location where a copy of the primary management information 41 is stored in another one primary block BLKp. This results in that the page numbers of the locations where the copies of the primary management information 41 are stored in the four primary blocks BLKp are different from each other. Thus, the page numbers of the locations where the copies of the primary management information 41 are stored in the four primary blocks BLKp differ from each other by one. Note that the page numbers of the locations where the copies of the primary management information 41 are stored in the four primary blocks BLKp may differ from each other by two or more.

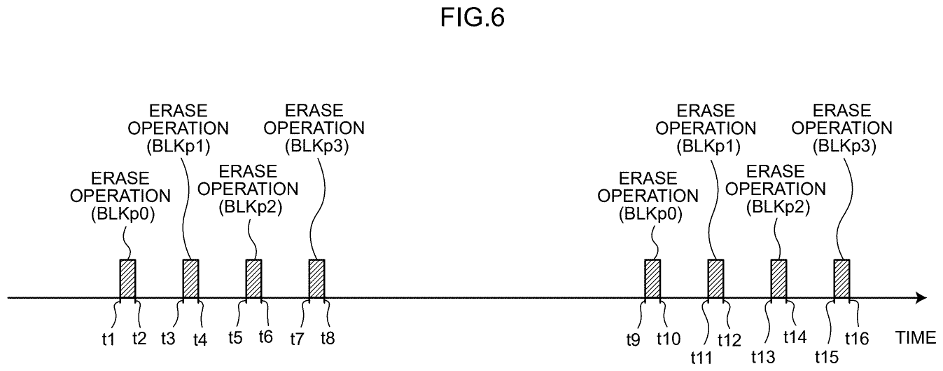

FIG. 6 is a diagram for explaining a timing of an erase operation for each primary block BLKp according to the first embodiment.

As illustrated in FIG. 6, an erase operation is executed on the primary block BLKp0 between time t1 and time t2. Thereafter, an erase operation is executed on the primary block BLKp1 from time t3 to time t4. Thereafter, an erase operation is executed on the primary block BLKp2 from time t5 to time t6. Thereafter, an erase operation is executed on the primary block BLKp3 from time t7 to time t8.

Further, after the time t8, an erase operation is executed on the primary block BLKp0 from the time t9 to the time t10. Thereafter, an erase operation is executed on the primary block BLKp1 from time t11 to time t12. Thereafter, an erase operation is executed on the primary block BLKp2 from time t13 to time t14. Thereafter, an erase operation is executed on the primary block BLKp3 from time t15 to time t16.

Since erase operations for the respective primary blocks BLKp are executed at different multiple storing operation timings, the erase operations are executed on the primary blocks BLKp in a temporally distributed manner as illustrated in FIG. 6.

Next, operations of the memory system 1 according to the first embodiment will be described.

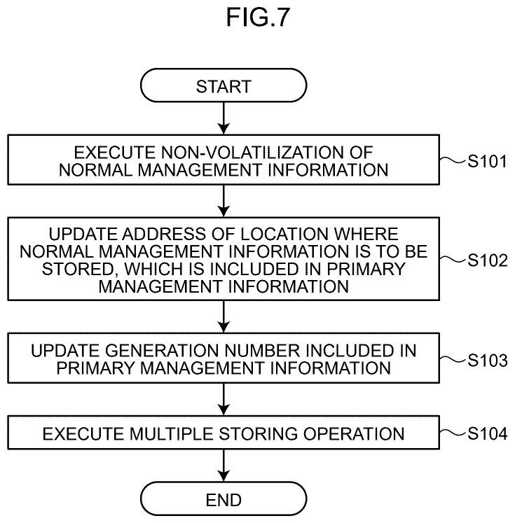

FIG. 7 is a flowchart illustrating a procedure of a series of operations related to non-volatilization of the normal management information 42 according to the first embodiment.

First, the memory controller 11 executes non-volatilization of the normal management information 42 (S101). Specifically, the memory controller 11 generates a copy of the normal management information 42 in the RAM 13 and stores the generated copy of the normal management information 42 into the NAND memory 12.

In response to the non-volatilization of the normal management information 42, the memory controller 11 updates an address of a location where the normal management information 42 is to be stored, which is included in the primary management information 41 (S102).

The memory controller 11 updates a generation number included in the primary management information 41 (S103).

The generation number is numerical information indicating the generation of the primary management information 41. The generation number may be incremented every time the processing of step S102 is executed. In a case where the generation number is incremented every time the processing of step S102, it means that the larger the generation number included in the primary management information 41, the newer the primary management information 41.

Subsequently, the memory controller 11 executes a multiple storing operation (S104). Then, the series of operations related to the non-volatilization of the normal management information 42 ends.

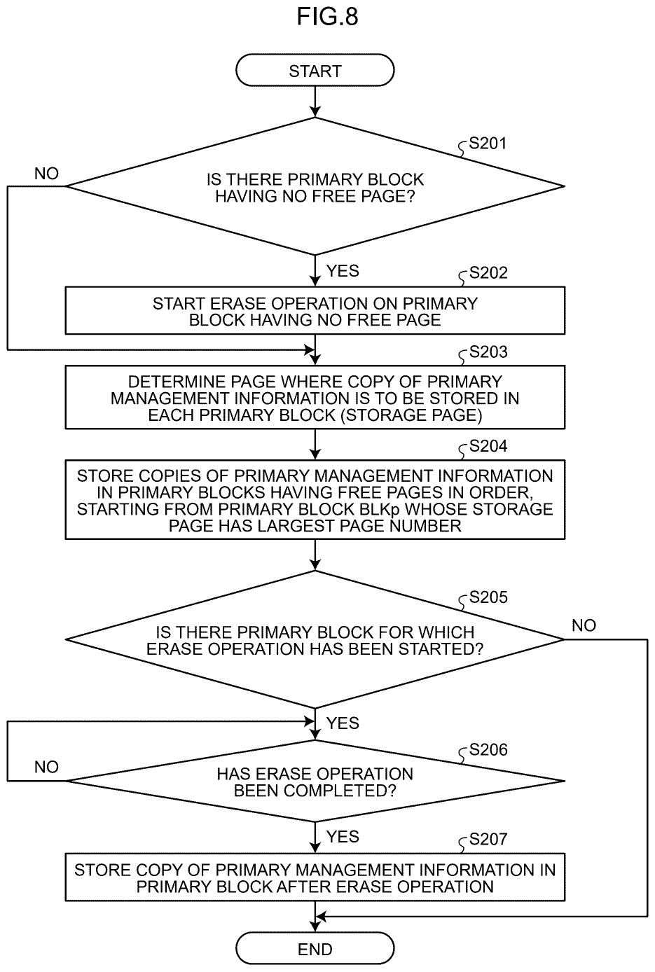

FIG. 8 is a flowchart illustrating a procedure of a multiple storing operation according to the first embodiment.

In the multiple storing operation, the memory controller 11 first determines whether there is a primary block BLKp having no free page (S201). When there is a primary block BLKp having no free page (S201: Yes), the memory controller 11 starts an erase operation on the primary block BLKp having no free page (S202).

When there is no primary block BLKp having no free page (S201: No) or after step S202, the memory controller 11 determines a page where a copy of the primary management information 41 is to be stored (hereinafter, a storage page) in each primary block BLKp (S203).

In step S203, for each primary block BLKp having a free page, a page having a page number obtained by adding 1 to a page number of a storage page in a previous multiple storing operation is determined as a storage page in the current multiple storing operation. For a primary block BLKp having no free page, the page P0 (more precisely, the page P0 after the erase operation) is determined as a storage page.

Following step S203, the memory controller 11 stores copies of the primary management information 41 in the primary blocks BLKp having free pages in order, for example, starting from a primary block BLKp whose storage page has the largest page number (S204).

The memory controller 11 determines whether there is a primary block BLKp on which the processing of step S202 has been performed, namely, a primary block BLKp on which the erase operation has been started (S205).

When there is a primary block BLKp on which the erase operation has been started (S205: Yes), the memory controller 11 determines whether the erase operation has been completed (S206).

When the erase operation has not been completed (S206: No), the memory controller 11 executes the processing of step S206 again. When the erase operation has been completed (S206: Yes), the memory controller 11 stores a copy of the primary management information 41 in the primary block BLKp on which the erase operation has been executed (S207).

When there is no primary block BLKp on which the erase operation has been started (S205: No), or after the processing of step S207, the multiple storing operation ends.

In the example described in FIG. 8, for each primary block BLKp, a storage page in the current multiple storing operation is determined based on a storage page in a previous multiple storing operation. The memory controller 11 may check whether the determined page numbers of the storage pages in the primary blocks BLKp are different among all the primary blocks BLKp. If the page numbers of the storage pages in two or more primary blocks BLKp become the same for some reason, the memory controller 11 may execute padding to one or more free pages for each of the one or more primary blocks BLKp, and reset the storage page of each primary block BLKp.

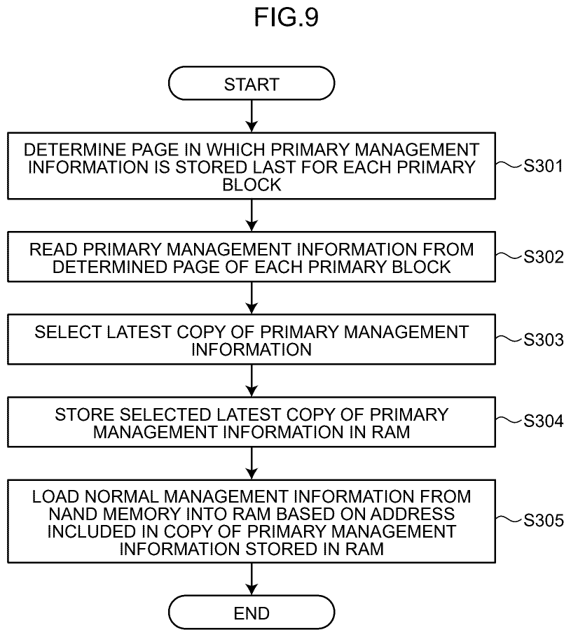

FIG. 9 is a flowchart illustrating a procedure of a series of operations related to loading of the normal management information 42 according to the first embodiment. The series of operations illustrated in FIG. 9 is executed when, for example, the memory controller 11 is booted.

The memory controller 11 determines a page in which a copy of the primary management information 41 is stored last for each primary block BLKp (S301).

A method for determining a page in which the copy of the primary management information 41 is stored last is optional. In one example, the memory controller 11 reads a certain page of the primary block BLKp, and determines whether the page is in an erased state based on data obtained by reading the page. This determination is also referred to as an erased word line search. The memory controller 11 sequentially selects one page from among pages included in one primary block BLKp based on a predetermined algorithm such as a binary tree search, and determines whether the selected page is in the erased state. The memory controller 11 repeatedly select a page and make a determination on the selected page to determine a page in which the copy of the primary management information 41 is stored last. The memory controller 11 executes such an operation of determining a page in which the copy of the primary management information 41 is stored last for each primary block BLKp.

The memory controller 11 reads the copy of the primary management information 41 from the determined page of each primary block BLKp (S302).

The memory controller 11 selects the latest copy of the primary management information 41 from a set of copies of the primary management information 41 read from different primary blocks BLKp (S303). In step S303, the memory controller 11 selects the latest copy of the primary management information 41 based on the generation information included in each set of copies of the primary management information 41.

The memory controller 11 stores the selected latest copy of the primary management information 41 in the RAM 13 (S304).

The memory controller 11 loads the normal management information 42 from the NAND memory 12 into the RAM 13 based on an address included in the copy of the primary management information 42 stored in the RAM 13 (S305).

Then, the series of operations related to the loading of the normal management information 42 ends. Thereafter, the memory controller 11 uses the copy of the primary management information 41 stored in the RAM 13 as the primary management information 41.

In the configuration according to the first embodiment described above, the primary block BLKp is an example of a storage area unit. Each of the pages included in the primary block BLKp is an example of a sub storage area. The page number is an example of a sub storage area number. The multiple storing operation is an example of a first operation. The NAND memory 12 is an example of a first memory. The RAM 13 is an example of a second memory. The copy of the primary management information 41 is an example of first information. The free page is an example of a free area in which the first information can be stored. The primary management information 41 in the RAM 13 is an example of second information.

As described above, according to the first embodiment, the memory controller 11 operates as follows in each multiple storing operation. That is, for a primary block BLKp having no free page among the primary blocks BLKp, the memory controller 11 executes an erase operation, and stores a copy of the primary management information 41 after executing the erase operation. For a primary block BLKp having a free page among the primary blocks BLKp, the memory controller 11 stores a copy of the primary management information 41 in the free page without executing an erase operation. The memory controller 11 respectively stores copies of the primary management information 41 in pages having different page numbers of the primary blocks BLKp.

Therefore, even when a multiple storing operation is started during a PLP operation, it is possible to reduce the risk that the time is insufficient for storing copies of the primary management information 41 in all the primary blocks BLKp. In addition, even if an erase operation is required in any of the primary blocks BLKp during a multiple storing operation, the multiple storing operation can be completed in a shorter time than in the second comparative example.

Thus, the primary management information 41 can be suitably stored in the NAND memory 12.

In addition, according to the first embodiment, the memory controller 11 stores the primary management information 41 in the RAM 13, and updates the primary management information 41 in the RAM 13. In a multiple storing operation, the memory controller 11 stores copies of the primary management information 41 in the RAM 13 into different primary blocks BLKp among the primary blocks BLKp.

Moreover, according to the first embodiment, in a first multiple storing operation, the memory controller 11 pads all the primary blocks BLKp except one, up to their pages having different page numbers.

Therefore, during multiple storing operations, for a primary block BLKp having free pages, the memory controller 11 can store a copy of the primary management information 41 in the current multiple storing operation in a page next to a page where a copy of the primary management information 41 was stored in a previous multiple storing operation. The memory controller 11 can differentiate the storage pages in the primary blocks BLKp.

In addition, according to the first embodiment, when the memory system 1 is booted, the memory controller 11 reads the copies of the primary management information 41 from the pages in which the copies of the primary management information 41 are respectively stored last in the primary blocks BLKp. Then, the memory controller 11 selects the latest copy of the primary management information 41 from the set of copies of the primary management information 41 read from the primary blocks BLKp. Then, the memory controller 11 stores the selected latest copy of the primary management information 41 in the RAM 13.

Note that, in the multiple storing operation according to the example described above, the memory controller 11 respectively stores copies of the primary management information 41 in pages having different page numbers of the primary blocks BLKp. The page numbers of the pages where the copies of the primary management information 41 are stored may not necessarily be different among all the primary blocks BLKp as long as they are different between at least two of the primary blocks BLKp.

Therefore, regarding the padding in the first multiple storing operation, the memory controller 11 may be configured to pad one or both of the at least two primary blocks BLKp, up to their pages having different page numbers.

In addition, information indicating an address of a location where the normal management information 42 is stored has been mentioned as an example of the primary management information 41. An example of the primary management information 41 is not limited thereto. Any of the management information 40 may be the primary management information 41, namely, a target of a multiple storing operation. Further, the target of the multiple storing operation is not limited to the management information 40. Any data can be a target of a multiple storing operation.

### Second Embodiment

In the second embodiment, firmware is a target of a multiple storing operation. Specifically, a plurality of blocks BLK where the firmware is to be stored are prepared, and the same firmware is stored in each of the prepared blocks BLK. Even if an abnormality occurs in any of the blocks BLK where the firmware is to be stored, it is prevented that the memory system cannot be booted.

In the second embodiment, a block BLK in which firmware is stored will be referred to as a primary block BLKp.

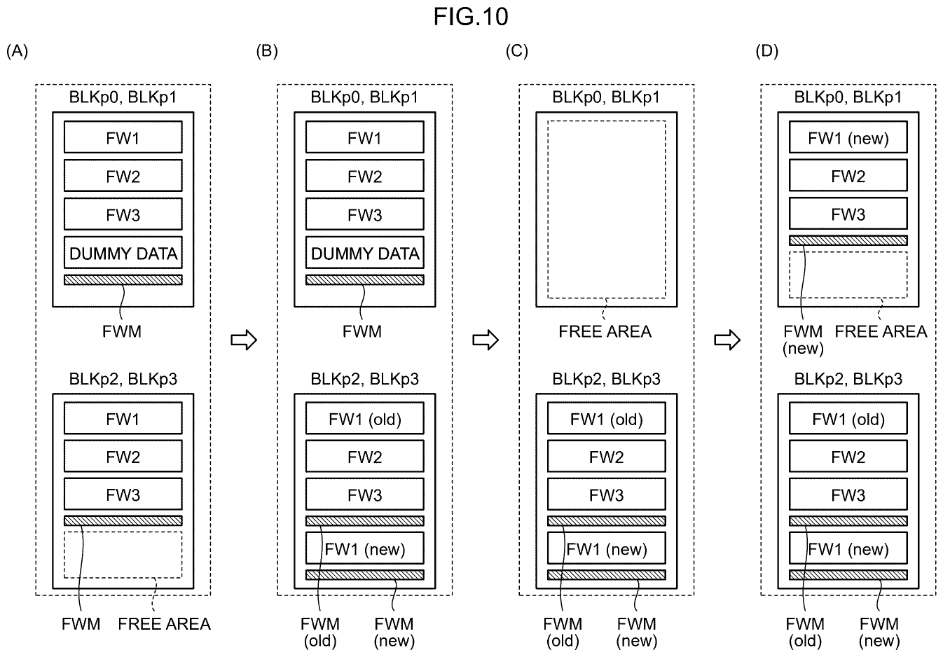

FIG. 10 is a diagram for explaining an example of a multiple storing operation according to the second embodiment. In the example illustrated in FIG. 10, four primary blocks BLKp are set in advance. The four primary blocks BLKp are a primary block BLKp0, a primary block BLKp1, a primary block BLKp2, and a primary block BLKp3.

In the example illustrated in FIG. 10, three pieces of executable firmware are stored in each primary block BLKp. A set of the three pieces of firmware will be referred to as a firmware set. The three pieces of firmware, which constitutes the firmware set, are distinguished from each other by type. Thus, in this example, one firmware set includes three types of firmware.

The primary blocks BLKp0 and BLKp1 store firmware in the same manner. The primary blocks BLKp2 and BLKp3 store firmware in the same manner. Therefore, in FIG. 10, a method of storing firmware in the primary blocks BLKp0 and BLKp1 is collectively illustrated, and a method of storing firmware in the primary blocks BLKp2 and BLKp3 is collectively illustrated.

In FIG. 10, the pages included in each primary block BLKp is not illustrated. In a rectangle representing each primary block BLKp, the pages are arranged in order of page number from an upper end to a lower end of the rectangle. Note that a location of a page P0 of each primary block BLKp, namely, a location of a page in which data is stored first in each primary block BLKp, may be referred to as a head of the primary block BLKp. When the primary block BLKp has one or more free pages, a free page having the smallest page number among the one or more free pages may be referred to as a head of a free area.

In the initial state, as illustrated in part (A), in each of the primary blocks BLKp0 and BLKp1, three types of firmware, i.e., firmware FW1, firmware FW2, and firmware FW3, are stored in this order from the head. These three types of firmware are all executable. Thus, the three types of firmware constitute a firmware set in the initial state. Dummy data is stored in an area following the area where the firmware set is stored, and firmware management information FWM for managing the firmware set is stored in an area following the area where the dummy data is stored.

In the initial state, in each of the primary blocks BLKp2 and BLKp3, three types of firmware, i.e., firmware FW1, firmware FW2, and firmware FW3, are stored in this order from the head. Thus, a firmware set is also stored in each of the primary blocks BLKp2 and BLKp3. In an area following the area in which the firmware set is stored, firmware management information FWM is stored without storing dummy data. Therefore, in each of the primary blocks BLKp2 and BLKp3, an area following the area in which the firmware management information FWM is stored is a free area.

A relationship among a size of each piece of firmware, a size of the firmware management information FWM, and a capacity of each primary block BLKp is determined such that the free area of each of the primary blocks BLKp2 and BLKp3 has a capacity capable of storing at least one pair of firmware and firmware management information FWM.

In the description of the second embodiment, in a case where the total capacity of one or more free pages included in a certain primary block BLKp is smaller than the size capable of storing a pair of firmware and firmware management information FWM, the certain primary block BLKp will be referred to as a primary block BLKp having no free area. In addition, in a case where the total capacity of one or more free pages included in a certain primary block BLKp is equal to or larger than the size capable of storing a pair of firmware and firmware management information FWM, the certain primary block BLKp will be referred to as a primary block BLKp having a free area. For example, in the initial state, each of the primary blocks BLKp0 and BLKp1 is a primary block BLKp having no free area, and each of the primary blocks BLKp2 and BLKp3 is a primary block BLKp having a free area.

When the firmware FW1 is updated with a new version of firmware FW1a, as illustrated in part (B), the memory controller 11 first stores the firmware FW1a and new firmware management information FWM in the free area of each of the primary blocks BLKp2 and BLKp3 in this order from the head of the free area. The new firmware management information FWM is firmware management information FWM corresponding to a new firmware set that includes the firmware FW1a, the firmware FW2, and the firmware FW3 stored in each of the primary blocks BLKp2 and BLKp3.

Each of the primary blocks BLKp0 and BLKp1 has no free area. Therefore, as illustrated in part (C), the memory controller 11 executes an erase operation on each of the primary blocks BLKp0 and BLKp1.

Then, as illustrated in part (D), the memory controller 11 stores firmware FW1a, the firmware FW2, the firmware FW3, and new firmware management information FWM from the head of each of the primary blocks BLKp0 and BLKp1. The new firmware management information FWM is firmware management information FWM corresponding to a new firmware set that includes the firmware FW1a, the firmware FW2, and the firmware FW3 stored in each of the primary blocks BLKp0 and BLKp1. An area following the area in which the new firmware management information FWM is stored is a free area. In a next multiple storing operation, next new firmware and new firmware management information FWM corresponding to a firmware set that includes the next new firmware can be stored in the free area.

In this manner, in a multiple storing operation, a primary block BLKp of one of the set of primary blocks BLKp0 and BLKp1 and the set of primary blocks BLKp2 and BLKp3 always has a free area. Then, in a next multiple storing operation, new firmware and new firmware management information FWM are stored in the primary block BLKp having the free area without executing an erase operation. A firmware set that includes new firmware and new firmware management information FWM is stored in a primary block BLKp having no free area after an erase operation.

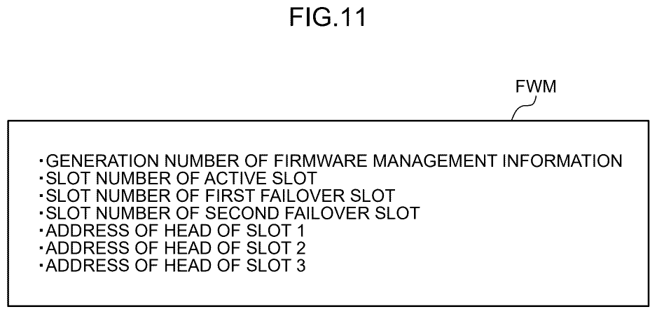

FIG. 11 is a diagram illustrating a configuration of firmware management information FWM according to the second embodiment.

A generation number of firmware management information FWM, a slot number of an active slot, a slot number of a first failover slot, a slot number of a second failover slot, an address of the head of slot 1, an address of the head of slot 2, and an address of the head of slot 3 are recorded in the firmware management information FWM.

An area in which each piece of firmware constituting a firmware set is stored in one primary block BLKp will be referred to as a slot. Each slot is identified by a slot number corresponding to the type of firmware stored therein. According to the example illustrated in FIG. 10, an area in which the firmware FW1 and the firmware FW1a are stored is identified as slot 1, an area in which the firmware FW2 is stored is identified as slot 2, and an area in which the firmware FW3 is stored is identified as slot 3.

A location of each slot in one primary block BLKp is identified by the address of the head of the slot 1, the address of the head of the slot 2, and the address of the head of the slot 3 recorded in the firmware management information FWM.

The active slot indicates a slot that stores firmware of the firmware set to be executed first in the booting. The first failover slot indicates a slot that stores firmware to be executed in a case where the booting by the firmware stored in the active slot fails. The second failover slot indicates a slot that stores firmware to be executed in a case where the booting by either the firmware stored in the active slot or the firmware stored in the first failover slot fails.

In this manner, the firmware management information FWM defines, for example, the order in which all types of firmware constituting the firmware set are executed, and the locations where all types of firmware constituting the firmware set are stored.

Note that, as illustrated in FIG. 10, the locations where various types of firmware constituting the firmware set are stored can be changed by performing a multiple storing operation. Therefore, during the multiple storing operation, the memory controller 11 updates the firmware management information FWM, and stores the updated new firmware management information FWM in each primary block BLKp. When updating the firmware management information FWM, the memory controller 11 updates the generation number of the firmware management information FWM as well.

In addition, the set of the primary blocks BLKp0 and BLKp1 and the set of the primary blocks BLKp2 and BLKp3 are different from each other in locations where various types of firmware constituting the firmware set are stored. Therefore, the new firmware management information FWM stored in each of the primary blocks BLKp0 and BLKp1 and the new firmware management information FWM stored in each of the primary blocks BLKp2 and BLKp3 are different from each other.

A technique to be compared with the second embodiment will be described. The technique to be compared with the second embodiment will be referred to as a third comparative example.

According to the third comparative example, an erase operation and storage of all types of firmware including new firmware and management information are performed on one set of primary blocks among two sets of primary blocks. Thereafter, an erase operation and storage of all types of firmware including new firmware and management information are performed on the other set of primary blocks.

Thus, according to the third comparative example, an erase operation and storage of all types of firmware including new firmware and management information are executed serially on two sets of primary blocks. Therefore, one multiple storing operation requires a very long time. Erase operations are executed on all the primary blocks in every multiple storing operation. Therefore, the number of program/erase cycles (P/E cycles) executed for each primary block increases, and each primary block wears out at a fast speed.

In contrast, according to the second embodiment of the present disclosure, new firmware is stored in one of the set of primary blocks BLKp0 and BLKp1 and the set of primary blocks BLKp2 and BLKp3 without executing an erase operation. Therefore, the time required for one multiple storing operation is shortened as compared with that in the third comparative example. The number of P/E cycles executed for each primary block BLKp is reduced, so that the speed at which each primary block BLKp wears out is reduced.

Note that the number of pieces of firmware constituting one firmware set (that is, the number of types of firmware here) is not limited to three. The number of pieces of firmware constituting one firmware set is optional as long as it is 1 or larger.

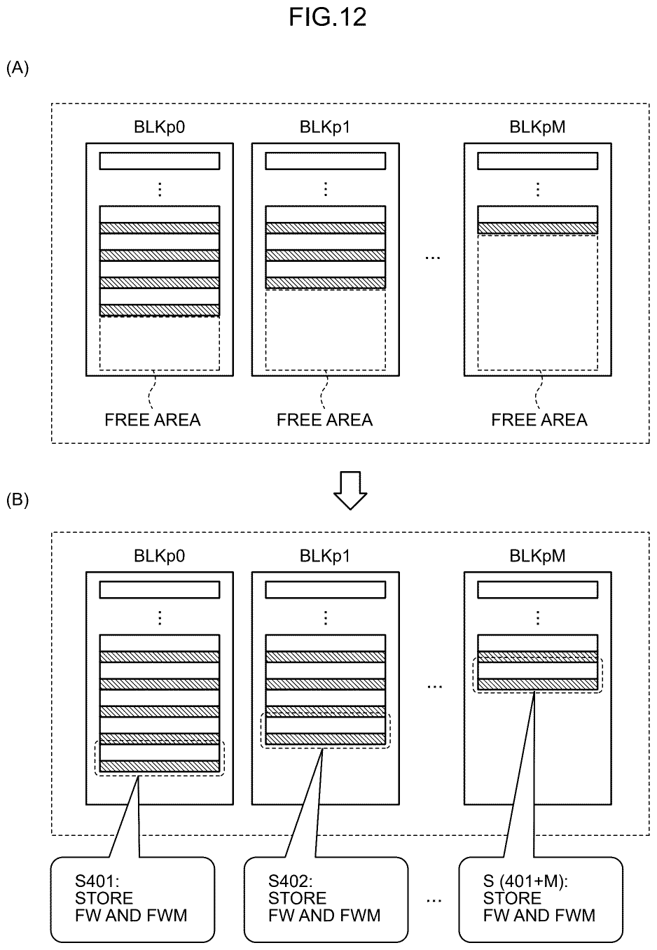

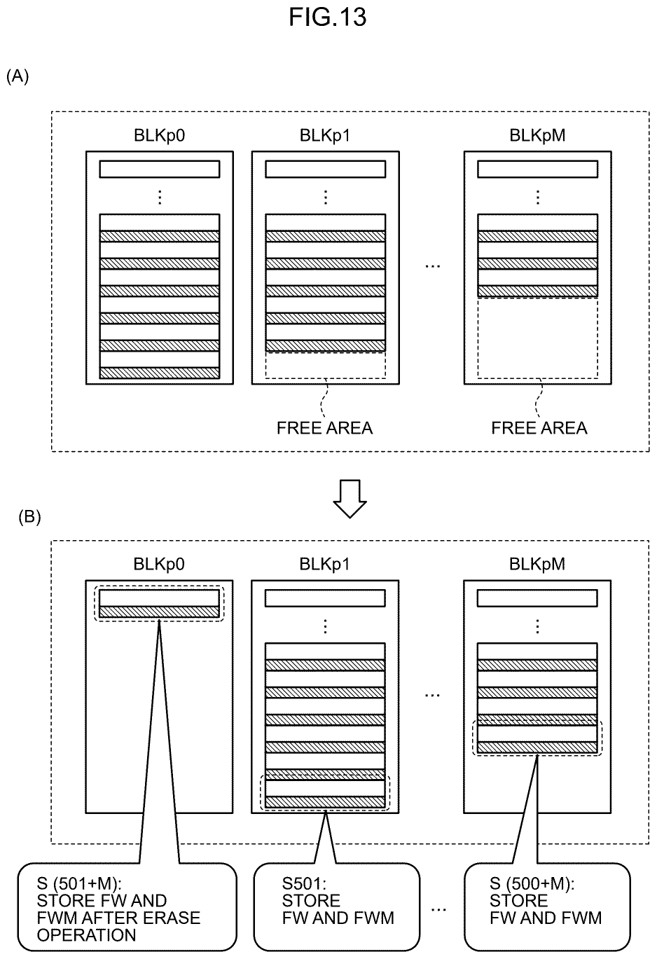

FIGS. 12 and 13 are diagrams each for explaining an example of a multiple storing operation in which the feature according to the second embodiment is more generalized.

In each of the examples illustrated in FIGS. 12 and 13, (M+1) primary blocks BLKp are set in advance. Here, M is an integer of 1 or larger. The (M+1) primary blocks BLKp are primary blocks BLKp0 to BLKpM. Among the objects shown in each primary block BLKp, an outlined rectangular object indicates firmware, and an obliquely hatched rectangular object indicates firmware management information FWM.

In each of the examples illustrated in FIGS. 12 and 13, firmware is stored in the (M+1) primary blocks BLKp in different modes.

According to part (A) of FIG. 12, each of the (M+1) primary blocks BLKp has a free area. The (M+1) primary blocks BLKp have free areas with different capacities. The free area of the primary block BLKp0 has the smallest capacity, the free area of the primary block BLKp1 has the second smallest capacity, and the free area of the primary block BLKpM has the largest capacity.

In a multiple storing operation for the (M+1) primary blocks BLKp in the state illustrated in part (A) of FIG. 12, the memory controller 11 stores updated firmware and new firmware management information FWM corresponding to a firmware set that includes the updated firmware, in the free area of each of the (M+1) primary blocks BLKp from the head of the free area.

Among the primary blocks BLKp having free areas, the order of storing the updated firmware and the new firmware management information FWM is not particularly limited. The memory controller 11 may store the updated firmware and the new firmware management information FWM in the primary blocks BLKp having free areas simultaneously. Alternatively, the memory controller 11 may store the updated firmware and the new firmware management information FWM in the primary blocks BLKp having free areas one-by-one.

In each of the examples illustrated in FIGS. 12 and 13, the memory controller 11 stores the updated firmware and the new firmware management information FWM in descending order of page number of the storage page for the primary blocks BLKp having free areas. Thus, the memory controller 11 stores the updated firmware and the new firmware management information FWM in ascending order of capacity of free area for the primary blocks BLKp having free areas.

Therefore, as illustrated in part (B) of FIG. 12, the memory controller 11 first stores updated firmware and new firmware management information FWM in the primary block BLKp0, which is a primary block BLKp having a free area of the smallest capacity (S401). Next, the memory controller 11 stores updated firmware and new firmware management information FWM in the primary block BLKp1, which is a primary block BLKp having a free area of the second smallest capacity (S402). In a similar procedure, the memory controller 11 sequentially stores updated firmware and new firmware management information FWM for primary blocks BLKp. Lastly, the memory controller 11 stores updated firmware and new firmware management information FWM in the primary block BLKpM, which is a primary block BLKp having a free area of the largest capacity (S(401+M)).

According to part (A) of FIG. 13, the primary block BLKp0 has no free capacity, and all the other primary blocks BLKp have free capacities. In such a case where there is a primary block BLKp having no free capacity, the memory controller 11 first stores updated firmware and new firmware management information FWM in the primary blocks BLKp1 to BLKpM having free capacities (S501 to S(500+M)). Then, the memory controller 11 executes an erase operation on the primary block BLKp0, and stores updated firmware and new firmware management information FWM in the primary block BLKp0 after the erase operation (S(501+M)).

In this manner, according to the second embodiment, in a multiple storing operation, the updated firmware for the primary blocks BLKp is stored in different areas of the primary blocks BLKp. With this processing, at least one of the primary blocks BLKp always has a free area. Then, in a next multiple storing operation, new firmware and new firmware management information FWM are stored in the primary block BLKp having a free area without executing an erase operation. A firmware set including new firmware and new firmware management information FWM are stored in the primary block BLKp having no free area after an erase operation is executed. Therefore, the time required for one multiple storing operation is shortened as compared with that in the third comparative example. In addition, the number of P/E cycles executed for each primary block BLKp is reduced, so that the speed at which each primary block BLKp wears out is reduced.

In any of the example illustrated in FIG. 10 and the examples illustrated in FIGS. 12 and 13, the new firmware management information FWM is stored after the updated firmware or the firmware set including the updated firmware in each primary block BLKp. When the memory system 1 is booted, the memory controller 11 reads the firmware management information FWM stored last in the primary blocks BLKp, and selects firmware to be executed based on the set of firmware management information FWM read from the primary blocks BLKp.

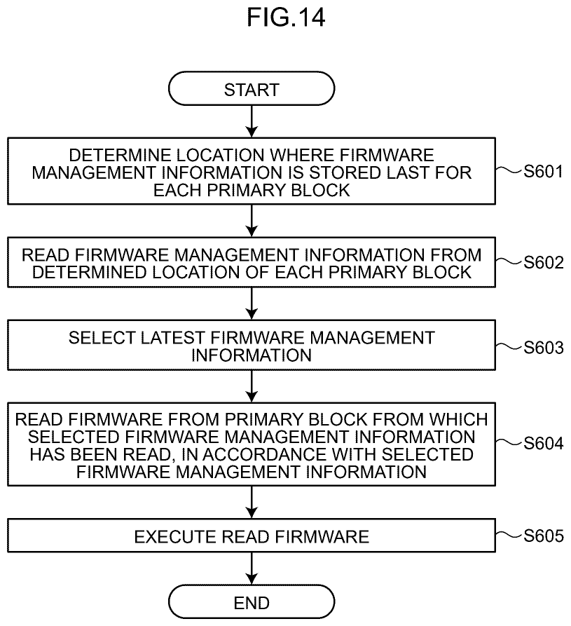

FIG. 14 is a flowchart illustrating an operation when booting the memory system 1 according to the second embodiment.

The memory controller 11 determines a location where the firmware management information FWM is stored last for each primary block BLKp (S601). Then, the memory controller 11 reads the firmware management information FWM from the determined location of each primary block BLKp (S602).

Any method may be used for determining the location where the firmware management information FWM is stored last and reading the firmware management information FWM. In one example, the memory controller 11 performs a read operation on locations in a primary block BLKp where the firmware management information FWM is likely to be stored, in order starting from a location having the largest page number, and determines whether the firmware management information FWM can be acquired by the read operation. In each piece of firmware management information FWM, a signature representing the firmware management information is recorded. The memory controller 11 determines whether the data acquired by reading the locations is data having a pattern matching the signature indicating that it is the firmware management information, thereby determining whether the firmware management information FWM has been acquired. The memory controller 11 regards the firmware management information FWM first acquired by sequentially reading the locations of one primary block BLKp as the firmware management information FWM stored last in the primary block BLKp.

The memory controller 11 selects the latest firmware management information FWM from a set of the firmware management information FWM read from the different primary blocks BLKp (S603). In step S603, the memory controller 11 selects the latest firmware management information FWM based on the generation information included in each piece of the firmware management information FWM.

The memory controller 11 reads the firmware from the primary block BLKp from which the selected firmware management information FWM has been read, in accordance with the selected firmware management information FWM (S604). By referring to the selected firmware management information FWM, the memory controller 11 determines a slot number of the active slot and an address of the head of the active slot. Then, the memory controller 11 reads the firmware from the determined slot in the primary block BLKp from which the selected firmware management information FWM has been read.

The memory controller 11 executes the read firmware (S605). Then, the operation when booting the memory system 1 ends. Here, the description of an operation when the booting with the read firmware fails is omitted.

In the configuration according to the second embodiment described above, the updated firmware and the new firmware management information FWM stored in each primary block BLKp in the multiple storing operation are an example of the first information.

As described above, according to the second embodiment, the memory controller 11 executes a multiple storing operation in response to the update of one piece of firmware included in a firmware set. In the multiple storing operation, the memory controller 11 stores information including the updated firmware in the primary blocks BLKp. The memory controller 11 differentiates, between at least two primary blocks BLKp, the locations where the updated firmware is to be stored, and thereby causes one primary block BLKp among the at least two primary blocks BLKp to include a free area.

Therefore, the time required for one multiple storing operation is shortened as compared with that in the third comparative example. In addition, the number of P/E cycles executed for each primary block BLKp is reduced, so that the speed at which each primary block BLKp wears out is reduced.

Therefore, firmware set can be suitably stored in the NAND memory 12.

According to the second embodiment, in each multiple storing operation, for a primary block BLKp having no free area, the memory controller 11 executes an erase operation, and after the erase operation, stores a firmware set including updated firmware instead of the firmware before the update. In each multiple storing operation, the memory controller 11 stores updated firmware in a primary block BLKp having a free area without executing an erase operation.

Therefore, the time required for one multiple storing operation is shortened as compared with that in the third comparative example. In addition, since the number of P/E cycles executed for each primary block BLKp is reduced, the speed at which each primary block BLKp wears out is reduced.

According to the second embodiment, in each multiple storing operation, the memory controller 11 stores a firmware set including updated firmware instead of the firmware before the update in a primary block BLKp having no free area, and then stores new firmware management information FWM in an area following the area where the firmware set is stored. For a primary block BLKp having a free area, the memory controller 11 stores updated firmware in the free area, and stores new firmware management information FWM in an area following the area in which the updated firmware is stored.

When the memory system is booted, the memory controller 11 reads the firmware management information FWM stored last in the primary blocks BLKp, and selects the latest firmware management information FWM from the set of the firmware management information FWM read from the primary blocks BLKp. Then, the memory controller 11 reads one piece of firmware from the primary block BLKp from which the selected firmware management information FWM has been read, based on the selected firmware management information FWM. Then, the memory controller 11 executes the read firmware.

In this manner, according to the first embodiment and the second embodiment, in each multiple storing operation, the memory controller 11 stores the first information in the primary blocks BLKp. In the first embodiment, the first information is a copy of primary management information 41. In the second embodiment, the first information includes one piece of updated firmware among pieces of firmware constituting a firmware set. In each multiple storing operation, for a primary block BLKp that does not have a free area in which the first information can be stored, the memory controller 11 executes an erase operation, and stores the first information after the erase operation. In each multiple storing operation, the memory controller 11 stores the first information in a primary block BLKp having a free area in which the first information can be stored without executing an erase operation. In each multiple storing operation, the memory controller 11 stores the first information in pages having different page numbers of at least two primary blocks BLKp, thereby causing at least one of the at least two primary blocks BLKp to have a free area in which the first information can be stored after the multiple storing operation.

Therefore, important data can be suitably stored in the nonvolatile memory.

While certain embodiments have been described, these embodiments have been presented by way of example only, and are not intended to limit the scope of the inventions. Indeed, the novel embodiments described herein may be embodied in a variety of other forms; moreover, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a nonvolatile first memory including a plurality of storage area units, each of the plurality of storage area units being a unit of an erase operation, each of the plurality of storage area units including a plurality of sub storage areas; and
a memory controller configured to:
manage, for each of the plurality of storage area units, each of the plurality of sub storage areas by using a sub storage area number in accordance with an order of data storage in the corresponding storage area unit; and
execute, on each of the plurality of storage area units, a first operation of storing first information a plurality of times, each of the plurality of times of the first operation including:
for a first storage area unit that is one of the plurality of storage area units and includes no free area capable of storing the first information, executing the erase operation on the first storage area unit and storing the first information in the first storage area unit after the erase operation;
for a second storage area unit that is one of the plurality of storage area units and includes a free area capable of storing the first information, storing the first information in the second storage area unit without executing the erase operation on the second storage area unit; and
in at least two of the plurality of storage area units, storing the first information in sub storage areas having different sub storage area numbers, and thereby causing at least one of the at least two storage area units to include the free area after the first operation.

2. The memory system according to claim 1, further comprising:
a volatile second memory, wherein
the memory controller is further configured to store second information in the second memory and update the second information stored in the second memory, and
the first information stored in each of the plurality of storage area units is a copy of the second information.

3. The memory system according to claim 1, wherein
the memory controller is further configured to, in a first time of the plurality of times of the first operation, differentiate, for the at least two storage area units, the sub storage area numbers of the sub storage areas where the first information is to be stored, the differentiating being performed by padding the sub storage areas having different sub storage area numbers in one or both of the at least two storage area units.

4. The memory system according to claim 3, further comprising:
a volatile second memory, wherein
the memory controller is further configured to, when the memory system is booted,
read the first information from one of the plurality of sub storage areas of each of the plurality of storage area units, in which the first information is stored last;
select the latest first information from a set of the first information read from the plurality of storage area units; and
store the selected first information in the second memory.

5. The memory system according to claim 1, wherein
the memory controller is further configured to, in each of the plurality of times of the first operation, store the first information in the sub storage areas having different sub storage area numbers of the plurality of storage area units.

6. The memory system according to claim 1, wherein
each of the plurality of storage area units stores a firmware set that includes R firmware programs (R is an integer of 2 or larger),
the memory controller is further configured to execute one of the plurality of times of the first operation in response to update of one firmware program of the firmware set, and
the first information includes a first firmware program that is the one firmware program after the update.

7. The memory system according to claim 6, wherein
the memory controller is further configured to, in each of the plurality of times of the first operation,
execute the erase operation on the first storage area unit; and
after the erase operation, store a first firmware set that includes the first firmware program, instead of the one firmware program before the update.

8. The memory system according to claim 7, wherein
the memory controller is further configured to, in each of the plurality of times of the first operation,
store the first firmware set in the first storage area unit after the erase operation, and store, in an area of the first storage area unit following an area in which the first firmware set is stored, first management information for managing the R firmware programs, which constitutes the first firmware set; and
store the first firmware program in the free area of the second storage area unit without executing the erase operation, and store, in an area of the second storage area unit following an area in which the first firmware program is stored, second management information for managing the R firmware programs, which constitutes the first firmware set.

9. The memory system according to claim 8, wherein
the memory controller is further configured to, when the memory system is booted,
read third management information stored last in each of the plurality of storage area units, the third management information being the first management information or the second management information;
select the latest third management information from a set of the third management information read from the plurality of storage area units;
based on fourth management information that is the selected third management information, read one firmware program from a storage area unit from which the fourth management information is read; and
execute the read one firmware program.

10. The memory system according to claim 1, wherein
each of the plurality of storage area units includes memory cell transistors each configured to store data in a nonvolatile manner in accordance with a threshold voltage, and
the free area includes one or more of the memory cell transistors on which a data storage operation has not yet been executed after the erase operation executed last.

11. A method of controlling a nonvolatile first memory that includes a plurality of storage area units, each of the plurality of storage area units being a unit of an erase operation, each of the plurality of storage area units including a plurality of sub storage areas, the method comprising:
managing, for each of the plurality of storage area units, each of the plurality of sub storage areas by using a sub storage area number in accordance with an order of data storage in the corresponding storage area unit; and
executing, on each of the plurality of storage area units, a first operation of storing first information a plurality of times, each of the plurality of times of the first operation including:
for a first storage area unit that is one of the plurality of storage area units and includes no free area capable of storing the first information, executing the erase operation on the first storage area unit and storing the first information in the first storage area unit after the erase operation;
for a second storage area unit that is one of the plurality of storage area units and includes a free area capable of storing the first information, storing the first information in the second storage area unit without executing the erase operation on the second storage area unit; and
in at least two of the plurality of storage area units, storing the first information in sub storage areas having different sub storage area numbers, and thereby causing at least one of the at least two storage area units to include the free area after the first operation.

12. The method according to claim 11, further comprising:
storing second information in a volatile second memory; and
updating the second information stored in the second memory, wherein
the first information stored in each of the plurality of storage area units is a copy of the second information.

13. The method according to claim 11, further comprising:
in a first time of the plurality of times of the first operation, differentiating, for the at least two storage area units, the sub storage area numbers of the sub storage areas where the first information is to be stored, the differentiating being performed by padding the sub storage areas having different sub storage area numbers in one or both of the at least two storage area units.

14. The method according to claim 13, wherein
the method is executed in a memory system, and
the method further comprises, when the memory system is booted,
reading the first information from one of the plurality of sub storage areas of each of the plurality of storage area units, in which the first information is stored last;
selecting the latest first information from a set of the first information read from the plurality of storage area units; and
storing the selected first information in a volatile second memory.

15. The method according to claim 11, further comprising:
in each of the plurality of times of the first operation, storing the first information in the sub storage areas having different sub storage area numbers of the plurality of storage area units.

16. The method according to claim 11, wherein
each of the plurality of storage area units stores a firmware set that includes R firmware programs (R is an integer of 2 or larger),
the method further comprises executing one of the plurality of times of the first operation in response to update of one firmware program of the firmware set, and
the first information includes a first firmware program that is the one firmware program after the update.

17. The method according to claim 16, further comprising, in each of the plurality of times of the first operation,
executing the erase operation on the first storage area unit; and
after the erase operation, storing a first firmware set that includes the first firmware program, instead of the one firmware program before the update.

18. The method according to claim 17, further comprising, in each of the plurality of times of the first operation,
storing the first firmware set in the first storage area unit after the erase operation, and storing, in an area of the first storage area unit following an area in which the first firmware set is stored, first management information for managing the R firmware programs, which constitutes the first firmware set; and
storing the first firmware program in the free area of the second storage area unit without executing the erase operation, and storing, in an area of the second storage area unit following an area in which the first firmware program is stored, second management information for managing the R firmware programs, which constitutes the first firmware set.

19. The method according to claim 18, wherein
the method is executed in a memory system, and
the method further comprises, when the memory system is booted,
reading third management information stored last in each of the plurality of storage area units, the third management information being the first management information or the second management information;
selecting the latest third management information from a set of the third management information read from the plurality of storage area units;
based on fourth management information that is the selected third management information, reading one firmware program from a storage area unit from which the fourth management information is read; and
executing the read one firmware program.

20. The method according to claim 11, wherein
each of the plurality of storage area units includes memory cell transistors each configured to store data in a nonvolatile manner in accordance with a threshold voltage, and
the free area includes one or more of the memory cell transistors on which a data storage operation has not yet been executed after the erase operation executed last.
